(19) United States
(12) Patent Application Publication
(10) Pub. No.: US 2010/0158228 A1
(43) Pub. Date: Jun. 24, 2010

(54) System and Method for Extending Services

(75) Inventors: David Mohler, Arvada, CO (US); Greg Weber, Westminster, CO (US)

Correspondence Address: AVAYA INC.;MARGARET CARMICHAEL, DOCKETING SPECIALIST, 1300 W. 120TH AVENUE, ROOM B1-F53, WESTMINSTER, CO, 80234, US

(73) Assignee: Avaya Inc., Basking Ridge, NJ (US)

(21) Appl. No.: 12/337,904

(22) Filed: Dec. 18, 2008

(51) Int. Cl. H04M 3/16

(52) U.S. Cl. 379/198

(57) ABSTRACT

The system and method associate a room telephone number with a guest telephone number. A predetermined time period is associated with the guest telephone number. Once a call is received from a telephone number, the system verifies that the calling telephone number matches the guest telephone number and that the call is within the predetermined time period. If there is a match between the calling telephone number and the guest telephone number and the call is within the predetermined time period, the call is enabled so that the guest can connect to one or more services.

### TECHNICAL FIELD

The system and method relates to telephony systems and in particular to hospitality telephony systems.

### BACKGROUND

Currently, in the hospitality industry, there are a variety of services that one can order from a room such as room service, laundry services, valet services, and the like. The hotel guest typically has to call from his room in order to have these services billed to his room. If the guest is not in his room, the guest typically does not have access the same services that he would have if he were in his room.

For example, PCT Publication Number WO 93/22856 describes a system that identifies a caller from a room based on the room number. Services are then allowed or denied based on status of the room (e.g., whether vacant or not). Messages and services are provided based on the status of the room. The problem with this system is that it requires the guest to be present in the room to obtain the services, it does not associate a guest's telephone number with the room telephone number, it does not allow multiple telephone numbers to be associated with one or more rooms, and it requires replacing existing systems that allow access to services.

Likewise, U.S. Patent Application Publication 2007/0176739 describes a system that associates a room number with the guest's telephone number. The guest can use the telephone number to unlock the door of the guest's room. However, this system fails to associate the guest's own telephone number with the room telephone number, requires replacing existing systems that allow access to services, and does not allow for multiple guest telephone numbers to be associated with one or more rooms.

### SUMMARY

The system and method are directed to solving these and other problems and disadvantages of the prior art. The system and method associate a room telephone number with a guest telephone number. A predetermined time period is associated with the guest telephone number. Once a call is received from a telephone number, the system verifies that the calling telephone number matches the guest telephone number and that the call is within the predetermined time period. If there is a match between the calling telephone number and the guest telephone number and the call is within the predetermined time period, the call is enabled so that the guest can connect to one or more services.

### BRIEF DESCRIPTION OF THE DRAWING

These and other features and advantages of the system and method will become more apparent from considering the following description of an illustrative embodiment of the system and method together with the drawing, in which:

FIG. 1 is a block diagram of a first illustrative system for enabling access to service(s).

FIG. 2 is a block diagram of a second illustrative system for enabling access to service(s).

FIG. 3 is a flow diagram of a method for allowing access to service(s).

FIG. 4 is a flow diagram of a method for verifying that a calling telephone number matches a guest telephone number and a predetermined time period(s).

FIG. 5 is a flow diagram of a method for providing different levels of access for guest telephone number(s) in an IVR system.

### DETAILED DESCRIPTION

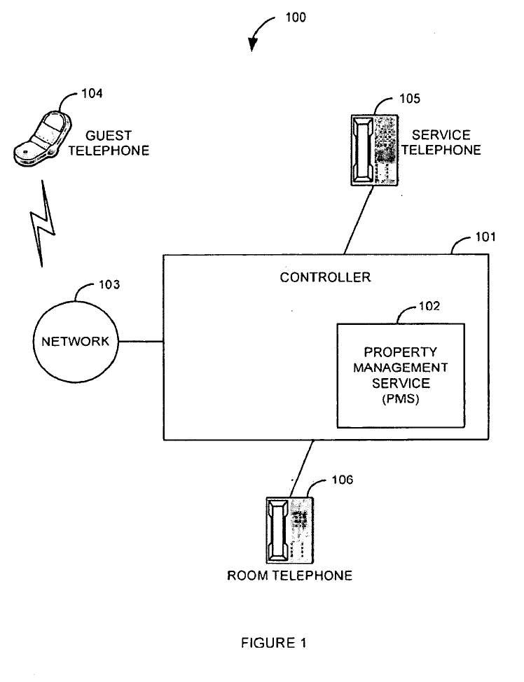

FIG. 1 is a block diagram of a first illustrative system 100 for enabling access to service(s). The first illustrative system 100 comprises a controller 101, a Property Management System (PMS) 102, a network 103, a guest telephone 104, a service telephone 105, and a room telephone 106. The PMS 102 in this example is included in the controller 101. However, the PMS 102 can reside as a separate entity outside the controller 101.

The controller 101 can be any device capable of handling calls such as a Session Initiation Protocol (SIP) proxy server, a PBX, a switch, a gateway, a central office switch, and the like. The PMS 102 can be any system and/or application capable of providing property management services such as a server, a PBX, a gateway, a software application, a reservation system, and the like. The network 103 can be any network or combinations of networks capable of routing calls such as the Internet, a SIP network, the Public Switched Telephone Network (PSTN), and the like. The guest telephone 104, the service telephone 105, and the room telephone can be any type of telephone such as a cellular telephone, an analog telephone, a digital telephone, an Integrated Digital Services Network (ISDN) telephone, and the like. The telephones (104-106) have an associated telephone number. The telephone number can be any type of telephone number such as a numeric telephone number, a SIP alpha-numeric number, a Uniform Resource Locator (URL), and the like.

The controller 101 associates a room telephone number with a guest telephone number. The room telephone number is associated with the room telephone 106. The guest telephone number is associated with the guest telephone 104. The PMS 102 associates a predetermined time period with the guest telephone number. The predetermined time period can be, for example, how long a guest (owner of the guest telephone 104) will stay in a hotel room. The predetermined time period can be changed dynamically to meet the need of the guest, the hotel, and the like.

A call is received at the controller 101 from a calling telephone. The PMS 102 verifies that the calling telephone number matches the guest telephone number. If there is a match, the PMS 102 checks whether the call is within the predetermined time period. If the calling telephone number matches the guest telephone number and the call is within the predetermined time period, the controller 101 enables the call to connect to the one or more services as if the guest telephone number were the room telephone number. For example, the call can be connected as if the caller picked up the room telephone 106. After the call is enabled to connect to the one or more services, the caller can connect to the one or more services in a variety of ways such as: interacting with an IVR system, dialing numbers as if the calling telephone number were the guest telephone number, dialing an operator, dialing a extension to connect to a service, dialing the front desk, placing a call, and the like.

As an example of how the first illustrative system 100 can work, consider the following example. John Smith makes a reservation at a hotel for November 13^{th}. The time that the hotel room is reserved is from 3:00 PM on the 13^{th} to 11:00 AM on the 14^{th}. John Smith's reservation is for room number 700. The room telephone 106 in room 700 has an extension of 0700. John Smith's cell phone 104 has a telephone number of 333-4444.

The controller 101 associates the room telephone number (0700) with John Smith's telephone number (333-4444). The PMS 102 associates the predetermined time period (3:00 PM on the 13^{th} to 11:00 AM on the 14^{th} with John Smith's telephone number (333-4444). The time period is dynamically adjustable in case of early check-out, check-in or any other event that would alter the initial time period. John Smith calls a central number from his cell telephone 104 at 6:00 PM on the 13^{th}. The controller 101 receives the call. The PMS 102 verifies that the incoming call number (333-4444) matches John Smith's number (333-4444). The PMS 102 verifies that the call from John Smith is within the predetermined time period. The call is connected as if the caller picked up the room telephone 106 and is enabled to connect to the service(s). John Smith can call various existing services as if John Smith were in room 700 using the room telephone 106 because the room telephone number is used to connect to the various services. The hotel does not have to change any of the existing methods for accessing services from the room. For example, John Smith can dial 0 connected to the operator, can dial *9 to place a local call, can dial *3 to call room service, can dial extension 0000 to get the front desk or call another guest, in room 701, of the hotel by dialing 0701.

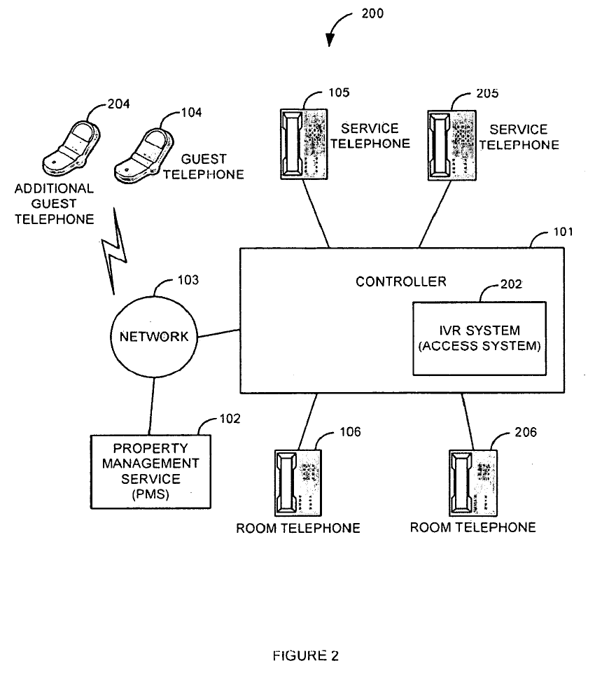

FIG. 2 is a block diagram of a second illustrative system 200 for extending service(s). The second illustrative system 200 comprises a controller 101, a Property Management System (PMS) 102, a network 103, a guest telephone 104, service telephones 105 and 205, room telephones 106 and 206, and an additional guest telephone 204. The controller 101 further comprises an Interactive Voice Response (IVR) system 202. The IVR system 202 is shown as part of the controller 101, but can be a separate entity external to the controller 101.

The controller 101 associates a room telephone number(s) with a guest telephone number and optionally one or more additional guest telephone numbers. The room telephone number(s) are associated with the room telephone(s) 106, 206. The guest telephone number is associated with the guest telephone 104. The one or more additional guest telephone number(s) are associated with the one or more additional guest telephone(s) 204. The PMS 102 associates a predetermined time period with the guest telephone number and optionally the additional guest telephone number(s). Different predetermined time period(s) can be associated with the guest telephone number and the additional guest telephone number(s). In addition, multiple predetermined time periods can be associated with a single guest telephone number.

A call is received at the controller 101 from a calling telephone. The PMS 102 verifies that the calling telephone number matches the guest telephone number or optionally matches the one or more guest telephone number(s). If there is a match, the PMS 102 verifies that the call is within the predetermined time period(s). If the calling telephone number matches the guest telephone number or optionally the one or more additional guest telephone numbers and the call is within the predetermined time period(s), the controller 101 enables the call to connect to one or more services (at the service telephone 105, 205) by connecting the call as if the caller picked up the room telephone 106, 206.

There are various ways that the controller 101 can enable the call to connect to the one or more services such as calling the IVR system 202. The IVR system 202 can direct the caller from the guest telephone 104 or the one or more additional guest telephones 204 to various services at the service telephones 105, 205. For example, one menu option in the IVR system 202 may direct the call to the room service telephone 105 and another option may direct the call to a maid service telephone 205.

The IVR system 202 can provide the guest telephone and/or the one or more additional guest telephone(s) with different levels of access. The IVR system 202 may allow the guest phone 104 to gain access to order movies, while the additional guest telephone 204 may not be allowed access to order movies based on preferences defined in the property management system 102. These preferences can be defined at various times such as when making reservations, at check in, at any time during the stay at the hotel, and the like. The different levels of access and preferences could be defined or allowed by other access systems such as a web server, a software application, and the like.

As an example of how the second illustrative system 200 can work, consider the following example. Jane Doe makes a reservation for two rooms at a hotel for December 20^{th}. One room is for her and her husband and one room is for their son Brad Doe. The predetermined time period that the hotel rooms are reserved is from 2:00 PM on the 20^{th} to 12:00 AM on the 21^{st}. Jane Doe and family are placed in room numbers 350 and 351. The room telephone 106 in room 350 has a telephone number of 100-0350. The room telephone 206 in room 351 has a telephone number of 100-0351. Jane Doe's cell phone 104 has a telephone number of 333-4444. Jane Doe's husband Bob Doe's cell phone 204 has a telephone number of 333-5555 and Brad Doe's cell phone 204 has a telephone number of 333-6666. Jane Doe sets up a preference that Jane Doe and Bob Doe will have access to all services, but that Brad Doe will only have access to restaurant room service. In addition, Brad Doe may also have specific financial limits to his restaurant access without the system sending a request to Jane or Bob to exceed such limits.

The controller 101 associates the room telephone numbers (100-0350 and 100-0351) with Jane Doe's telephone number (333-4444), Bob Doe's telephone number (333-5555), and Brad Doe's telephone number (333-6666). The PMS 102 associates the predetermined time period (2:00 PM on the 20^{th} to 12:00 AM on the 21^{st} with all three telephone numbers (333-4444, 333-5555, and 333-6666). Jane Doe calls the 100-3050 from her cell telephone 104 at 1:00 PM on the 20^{th} of December. The controller 101 receives the call. The PMS 102 verifies that the incoming call number (333-4444) matches Jane Doe's number (333-4444). However, the PMS 102 verifies that the call from Jane Doe is not within the predetermined time period (the predetermined time period does not start till 2:00 PM on the 20^{th} of December). Jane Doe is therefore denied access to the hotel's services or alternatively can be queried for whether she and her party desire early check-in.

Jane Doe calls the number 100-0350 after she has checked in at 4:00 PM on the 20^{th} of December while she is driving to a business function. The PMS 102 verifies that the incoming call number (333-4444) matches Jane Doe's number (333-4444). The PMS 102 verifies that call from Jane Doe is within the predetermined time period. The call is enabled to connect to the one or more services as if the calling telephone number were the room telephone number. At this point, Jane Doe can call all services as if Jane Doe were in room 350 using the room telephone 106. In this example, the call is directed to the IVR system 202. The IVR system 202 plays a menu of all service options that the hotel offers. Jane selects the laundry service. A call is placed to the laundry service telephone 105. Jane Doe requests that the laundry service pick up her dress in the closet of room 350 for cleaning by tomorrow. The hotel bills the cleaning to Jane Doe's bill because the call came from telephone number 100-0350 Brad Doe calls from the lobby of the hotel to 100-0351 with his cell telephone 204(333-6666) at 6:00 on the 20^{th} of December. The PMS 102 verifies that the incoming call number (333-6666) matches the guest telephone number or the one or more additional guest telephone numbers (333-4444, 333-5555, or 333-6666). The PMS 102 verifies that the call from Brad Doe is within the predetermined time period. Brad Doe is connected to the IVR system 202 as if he were in room 351. Only the message for restaurant room service is played by the IVR system 202. Brad Doe selects the restaurant room service option and a call is made to the restaurant service telephone 205.

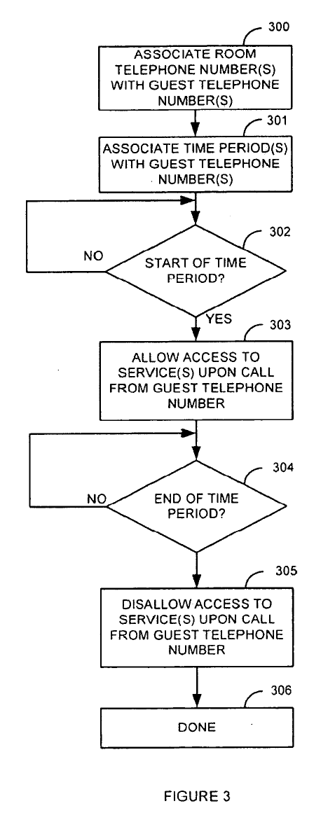

FIG. 3 is a flow diagram of a method for allowing access to service(s). Illustratively, the controller 101, the PMS 102, and the IVR system 202, are stored-program-controlled entities, such as a computer, which performs the method of FIGS. 3-5 by executing programs stored in storage media, such as a memory or disk. The process begins by associating 300 one or more room telephone number(s) with one or more guest telephone numbers. One or more predetermined time periods are associated 301 with the one or more guest telephone numbers. For example, a room may be reserved for two days for two guests, but the first guest is staying for the full two days and the second guest is only staying for one day. The predetermined time period associated with the first guest will be two days and the predetermined time period associated with the second guest is one day.

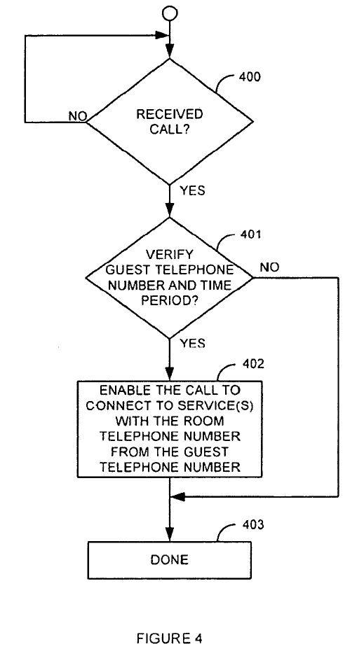

The process determines 302 if the start of the predetermined time period for the specific guest telephone 104, 204 has begun. If the predetermined time period has not begun, the process repeats step 302. If the predetermined time period has begun, in step 302, the process allows 303 access to one or more services upon receiving a call from the guest telephone number (see FIG. 4). The process determines 304 if the end of the predetermined time period has occurred. If the end of the predetermined time period has not occurred, the process repeats step 304. Otherwise, if the end of the predetermined time period has occurred, the process disallows 305 access to the one or more services upon a call from the guest telephone number. The process is then done 306. If there are multiple predetermined time periods associated with multiple guest telephone numbers, steps 302-306 are repeated for each predetermined time period associated with a guest telephone number. Example ways of checking predetermined time periods in software would be to spin off a different thread for each predetermined time period or to periodically poll to see if each predetermined time period has started or expired. The steps of 302-306 can be repeated based on one or more events such as when the user calls or requests a service. This will allow changes to be made dynamically to the predetermined time period(s) for the specific guest telephone. For example, if the user checks-in early or extends the check-out time, the predetermined time period can be changed to reflect the new check-in/check-out time. Now, when the user requests a service(s), he/she will now have access to the service(s) because the predetermined time period has been changed.

FIG. 4 is a flow diagram of a method for verifying that a calling telephone number matches a guest telephone number and a predetermined time period(s). The process waits 400 to receive a call. The call can be to a room telephone number, to a central number, or any designated telephone number. If a call has not been received, the process repeats step 400. If a call is received in step 400, the process verifies 401 that the calling telephone number is one of the guest telephone numbers and that the call is within the predetermined time period(s). If the calling number is not one of the guest telephone numbers or the call is not within the predetermined time period(s), the process is done 403. Otherwise, the call is enabled 402 by connecting the guest telephone 104, 204 to a system that can direct the guest to access one or more services. The process is then done 403.

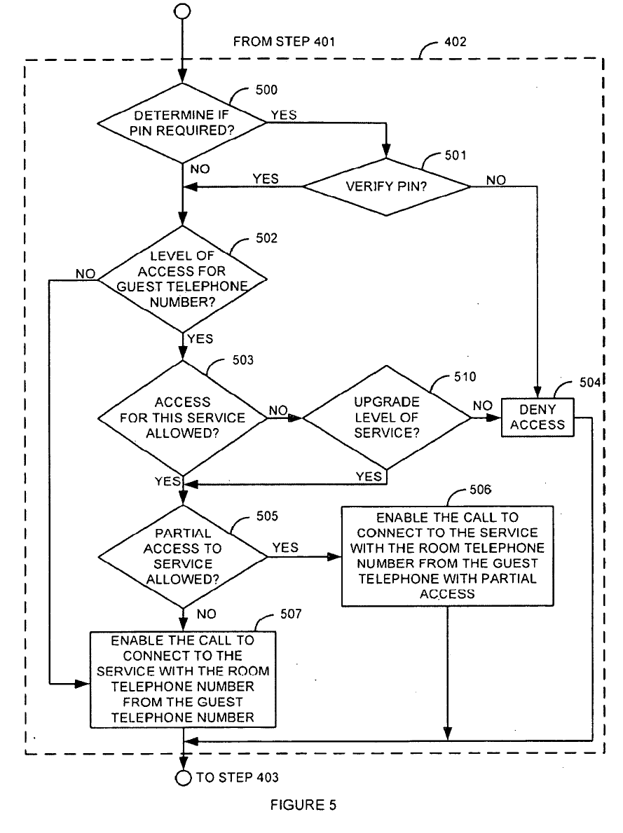

FIG. 5 is a flow diagram of a method for providing different levels of access for guest telephone number(s) in an IVR system 202. FIG. 5 is an expanded view of step 402 in FIG. 4. After verifying the guest telephone number and predetermined time period in step 401, the IVR system 202 determines 500 if a Personal Identification Number (PIN) is required. If a PIN is not required, the process goes to step 502. If a PIN is required, the IVR system 202 checks 501 whether the PIN is valid. If the PIN is not valid, the IVR system 202 denies access 504 and the process is done 403.

Otherwise, if the PIN was verified in step 501 or a PIN was not required in step 500, the IVR system 202 determines 502 if there is a level of access that has been granted to the guest telephone number which allows access to the one or more services. If there is not a level of access associated with the guest telephone number in step 502, the process goes to step 507. Otherwise, if there is a level of access to the one or more services associated with the guest telephone in step 502, the process determines 503 if access for a requested service is allowed in the level of access for the guest telephone number. If access is not allowed for the requested service in step 503, the process determines 510 if the user wants to dynamically upgraded his/her level of service. If the user does not want to upgraded his/her level of service, the process denies 504 access to the service and the process is done 403. Otherwise, the process goes to step 505. Upgrading the service level can be where the user is asked dynamically for a confirmation code to upgrade the service level, where the customer provides a credit card to get access to the service, and the like.

If access is allowed in step 503 or the level of service is upgraded in step 510, the process determines 505 if partial access to the service is allowed. Examples of allowing partial access to a service can be where the guest telephone is only allowed to order specific movies (e.g. G and PG), only being able to order specific menu items, only being able to order a specific amount, and the like. If partial access is allowed in step 505, the call is enabled 506 to connect to the service using the room telephone number from the guest telephone number with partial access. For example, an IVR system 202 may not list options in the menu of a specific service if partial access is allowed, whereas if full access was granted, all the menu items would be listed. Otherwise, if partial access is not allowed in step 505 or there is no level of access for the guest telephone number in step 502, the process enables 507 the call to connect to the service with the room telephone number from the guest telephone number.

Of course, various changes and modifications to the illustrative embodiment described above will be apparent to those skilled in the art. Other variations include upgrades of service in regard to food, gambling, spending limits, access to special services, and the like. Still other variations include the ability to monitor and report on spending either cumulatively or in aggregate. Such monitoring and reporting of spending limits might have predetermined watermarked levels where the customer wants to be alerted to approaching or exceeding the watermark. Other variations on this illustrative embodiment can be enforcement of laws or hospitality policy such as use of specific facilities or activities where one must be a certain age, possess certifications (such as a drivers license, a boaters license, or the like). These changes and modifications can be made without departing from the spirit and the scope of the system and method and without diminishing its attendant advantages. It is therefore intended that such changes and modifications be covered by the following claims except insofar as limited by the prior art.

What is claimed:

1. A system for controlling access to services comprising:
a. a controller configured to associate a room telephone number with a guest telephone number, receive a call from a calling telephone number, and enable the call to connect to one or more services as if the calling telephone number were the room telephone number, responsive to the calling telephone number matching the guest telephone number and the call being within a predetermined time period; and
b. a property management system configured to associate the predetermined time period with the guest telephone number, verify that the guest telephone number matches the calling telephone number, and verify that the call is within the predetermined time period.

2. The system of claim 1, further comprising an IVR system configured to verify a PIN number.

3. The system of claim 1, wherein the controller is configured to associate one or more additional room telephone numbers with the guest telephone number.

4. The system of claim 1, wherein the controller is configured to associate one or more additional guest telephone numbers with the room telephone number.

5. The system of claim 4, wherein the property management system is configured to associate a second predetermined time period with at least one of the one or more additional guest telephone numbers.

6. The system of claim 4, further comprising an access system configured to provide the guest telephone number and/or the one or more additional guest telephone numbers with different levels of access to the one or more services.

7. The system of claim 6, wherein the access system is an item selected from the group comprising: an IVR system, a web server, and a computer executing a software application.

8. The system of claim 6, wherein the different levels of access are an item selected from the group comprising: full service, partial service, and no service.

9. The system of claim 8, wherein the different levels of access are provided based on an item selected from the group comprising: an age, a drivers license, a boaters license, a certification, and a spending limit.

10. The system of claim 1, wherein the guest telephone number is an item selected from the group comprising: a numeric number, an alpha-numeric number, and a URL.

11. The system of claim 1, wherein the guest telephone number is associated with a device selected from the group comprising: a cellular telephone, a PDA, an analog telephone, a personal computer, and a digital device.

12. The system of claim 1, wherein the one or more services are an item selected from the group comprising: a telephone service, an operator service, a restaurant service, a laundry service, a valet service, a maid service, a limo service, a front desk service, a concierge service, and a bar service.

13. The system of claim 1, wherein the controller is configured to enable the call to connect to the one or more services by at least one item selected from the group comprising: automatically calling the one or more services, directing the call to an IVR system, directing the call to a device, providing a dial tone, enabling a guest to dial a telephone number, and enabling a guest to dial digits.

14. The system of claim 1, wherein the predetermined time period can be changed dynamically.

15. The system of claim 1, wherein access to the service can be upgraded dynamically.

16. A computer-implemented method for controlling access to services comprising:
a. associating a room telephone number with a guest telephone number;
b. associating a predetermined time period with the guest telephone number;
c. receiving a call from a calling telephone number;
d. verifying that the guest telephone number matches the calling telephone number;
e. verifying that the call is within the predetermined time period; and
f. responsive to verifying that the guest telephone number matches the calling telephone number and the call is within the predetermined time period, enabling the call to connect to one or more services as if the calling telephone number were the room telephone number.

17. The method of claim 16, further comprising the step of: verifying a PIN number.

18. The method of claim 16, wherein associating the room telephone number with the guest telephone number further comprises the step of: associating one or more additional room telephone numbers with the guest telephone number.

19. The method of claim 16, wherein associating the room telephone number with the guest telephone number further comprises the step of: associating one or more additional guest telephone numbers with the room telephone number.

20. The method of claim 19, wherein the step of associating one or more additional guest telephone numbers further comprises the step of: associating a second predetermined time period with at least one of the one or more additional guest telephone numbers.

21. The method of claim 19, further comprising the step of: providing the guest telephone number and/or the one or more additional guest telephone numbers with different levels of access to the one or more services.

22. The method of claim 21, wherein different levels of access are provided by an item selected from the group comprising: an IVR system, a web server, and computer executing a software application.

23. The method of claim 21, wherein the level of access is an item selected from the group comprising: full service, partial service, and no service.

24. The method of claim 23, wherein the different levels of access are provided based on an item selected from the group comprising: an age, a drivers license, a boaters license, a certification, and a spending limit.

25. The method of claim 16, wherein the guest telephone number is an item selected from the group comprising: a numeric number, an alpha-numeric number, and a URL.

26. The method of claim 16, wherein the guest telephone number is associated with a device selected from the group comprising: a cellular telephone, a PDA, an analog telephone, a personal computer, and a digital device.

27. The method of claim 16, wherein the one or more services are an item selected from the group comprising: a telephone service, an operator service, a restaurant service, a laundry service a valet service, a maid service, a limo service, a front desk service, a concierge service, and a bar service.

28. The method of claim 16, wherein enabling the call to connect to the one or more services is accomplished by at least one item selected from the group comprising: automatically calling the one or more services, directing the call to an IVR system, directing the call to a device, providing a dial tone, enabling a guest to dial a telephone number, and enabling a guest to dial digits.

29. The method of claim 16, wherein the predetermined time period can be changed dynamically.

30. The method of claim 16, wherein access to the service can be upgraded dynamically.

31. An apparatus for performing the method of one of claims 16-30.

32. An apparatus for controlling access to services comprising:
a. means for associating a room telephone number with a guest telephone number;
b. means for associating a predetermined time period with the guest telephone number;
c. means for receiving a call from a calling telephone number;
d. means for verifying that the guest telephone number matches the calling telephone number;
e. means for verifying that the call is within the predetermined time period; and
a. means responsive to verifying that the guest telephone number matches the calling telephone number and that the call is within the predetermined time period, for enabling the call to connect to one or more services as if the guest telephone number were the room telephone number.

33. A system for controlling access to services comprising:
a. a controller configured to associate a room telephone number with a guest telephone number, receive a call from a calling telephone number, and enable the call to connect to one or more services as if the guest telephone number were the room telephone number, responsive to a verification that the guest telephone number matches the calling telephone number and that the call is within a predetermined time period;
b. a property management system configured to associate the predetermined time period with the guest telephone number, verify that the guest telephone number matches the calling telephone number, and verify that the call is within the predetermined time period; and
c. an IVR system configured to receive the call from the guest telephone number, verify a PIN number, provide a menu of services based on a level of access to the services that are associated with guest telephone number, and route the call to a service telephone based on selection of one of the services from the menu of services.

34. A computer-implemented method for controlling access to services comprising:
a. associating a room telephone number with a guest telephone number;
b. associating a predetermined time period with the guest telephone number;
c. receiving a call from a calling telephone number;
d. verifying that the guest telephone number matches the calling telephone number;
e. verifying that the call is within the predetermined time period;
f. responsive to verifying that the guest telephone number matches the calling telephone number and that the call is within the predetermined time period, enabling the call to connect to one or more services as if the guest telephone number were the room telephone number;
g. receiving the call from the guest telephone number at an IVR system;
h. verifying a PIN number;
i. providing a menu of services based on a level of access to the services that are associated with the guest telephone number; and
j. routing the call to a service telephone based on selection of one of the services from the menu of services.

35. A computer-implemented method for controlling access to services comprising:
a. associating at least one guest telephone number and services available to the at least one guest telephone number with at least one room telephone number;
b. associating at least one predetermined time period with the at least one guest telephone number;
c. receiving a call from a calling telephone number at a room telephone number;
d. verifying whether the at least one guest telephone number matches the calling telephone number;
e. verifying whether the call is within the at least one predetermined time period; and
f. responsive to the at least one guest telephone number matching the calling telephone number and the call being within the at least one predetermined time period, enabling the call to connect to one or more of the available services; and
g. responsive to the calling telephone number not matching the at least one guest telephone number or the call not being within the at least one predetermined time period, preventing the call from connecting to any of the available services.

36. The method of claim 29 further comprising:
h. associating a PIN with the guest telephone number;
i. receiving a PIN from a party making the call; and
j. determining whether the received PIN matches the associated PIN; wherein enabling comprises:
k. responsive to the at least one guest telephone number matching the calling telephone number and the call being within the at least one predetermined time period and the received PIN matching the associated PIN, enabling the call to connect to one or more of the available service.
